(19) United States
(12) Patent Application Publication
(10) Pub. No.: US 2018/0109766 A1
(43) Pub. Date: Apr. 19, 2018

(54) REGIONAL IMAGE SCANNING SYSTEM AND METHOD THEREOF

(71) Applicant: JETEAZY SYSTEM CO., LTD., Hsinchu City (TW)

(72) Inventor: Cheng-Hsin TSAI, Hsinchu City (TW)

(73) Assignee: JETEAZY SYSTEM CO., LTD., Hsinchu City (TW)

(21) Appl. No.: 15/294,096

(22) Filed: Oct. 14, 2016

(51) Int. Cl. H04N 7/18; H04N 5/232; H04N 5/265

(52) U.S. Cl. CPC H04N 7/185; H04N 5/265; H04N 5/23216

(57) ABSTRACT

A regional scanning system and method thereof is provided and the scanning system includes at least one image device, a mobile device, a controlling and driving device, and an image processing device. The mobile device moves isochronally and equidistantly. The image device is installed on the mobile device and sequentially captures a plurality of regional images of a target object, and the image device is tilted at an angle relative to the horizontal plane. The controlling and driving device is connected to the image device to receive a plurality of regional images and connected to the mobile device to adjust a moving speed and a moving distance of the mobile device. The image processing device is disposed within the controlling and driving device to process the regional images.

### BACKGROUND OF THE INVENTION

### 1. Field of the Invention

The present invention relates to an image scanning system and method thereof, and more particularly to an image scanning system and method thereof to capture images regionally.

### 2. Description of Related Art

In order to satisfy an instant detecting request in a production line, a conventional technology implements a line scanning method in an image system to acquire a picture for a target. Scanned images of the target are transmitted to a control system with image processing functions to perform image processing and integration. A machine inspection replaces an inspection by human eyes to achieve a high speed and high accuracy detection. Accordingly, those mass-produced products are inspected by the line scanning method instead of the human eye inspecting method. Real examples using the line scanning method in the manufactures, such as food industries, mineral industries, electronics or automotive industries, etc, are easy to be found.

The conventional line scanning system mainly implements a stepper motor, a line scanning image acquiring apparatus and an image correcting apparatus. The stepper motor is used to sequentially move the line scanning image acquiring apparatus to perform a sequential scanning and capturing on a target object. The images acquired from the target object are transmitted to the image correcting apparatus to perform an image correction and integration. The scanned images in the line scanning system will be affected by a line scanning frequency, a working distance, an exposure time and a moving speed on a working platform. In addition, the conventional line scanning system requires a specific digital camera. When capturing the images in the line scanning method, the line scanning system takes the pictures of the target object by a vertical scanning way and a lateral area of the target may not be captured by the line scanning method. Therefore, some of the regions in the target object may not be detected.

Accordingly, the conventional line scanning system is required to be improved to overcome the shortcomings.

### SUMMARY OF THE INVENTION

An objective of the present invention is to provide a regional image scanning system and the regional image scanning system can capture regional images of a target object to mitigate the drawback that some of the areas cannot be captured in the conventional line scanning method. In addition, a normal digital camera can be used in the present invention.

According to the aforementioned objective, a regional image scanning system includes a mobile device, at least one image device, a controlling and driving device, and an image processing device. The mobile device moves isochronally and equidistantly. The at least one image device is installed on the mobile device and sequentially captures a plurality of regional images of a target object. The at least one image device is relatively tilted at an angle relative to the horizontal plane. The controlling and driving device is connected to the at least one image device to receive a plurality of regional images and connected to the mobile device to adjust a moving speed and a moving distance of the mobile device. The image processing device is disposed within the controlling and driving device to process the regional images.

Another objective of the present invention is to develop a regional image scanning method in the present invention. By the regional image scanning method, regional image for the target object can be merged to be a complete picture so as to determine whether the target object is abnormal or not.

In order to achieve the aforementioned purpose in the present invention, a regional image scanning method includes the following steps: installing at least one image device on a mobile device and the at least one image device tilted at an angle relative to a horizontal plane; moving the at least one image device isochronally and equidistantly by controlling the mobile device via a controlling and driving device; capturing a target object by moving the at least one image device to sequentially generate a plurality of regional images of the target object; transmitting the regional images to the controlling and driving device; and integrating the regional images by an image processing device within the controlling and driving device to be a complete picture of the target object.

The advantage of the present invention is to implement the regional scanning method to capture regional images for the target object so as to include a wider capturing area. Therefore, the areas that cannot be captured by the line scanning method can be captured by the regional image scanning method in the present invention. In addition, it is not necessary to use any unique photographic equipment, and normal digital cameras can be used to perform the regional image scanning method in the present invention.

### BRIEF DESCRIPTION OF THE DRAWINGS

FIG. 1 is a schematic view of a regional image scanning system in the present invention;

FIG. 2 is a view of the installation of the image device in the present invention;

FIG. 3 is a flowchart of the regional image scanning method in the present invention;

FIG. 4A-FIG. 4C are views illustrating that the regional image scanning system captures the target object in the present invention;

FIG. 5 is a view illustrating that the image device capturing the lateral area of the target object in the present invention; and

FIG. 6A-FIG. 6C are views illustrating that the regional images of the target object are integrated by the image processing device in the present invention.

### DETAILED DESCRIPTION OF THE PREFERRED EMBODIMENT

These and other aspects of the embodiments herein will be better appreciated and understood when considered in conjunction with the following description and the accompanying drawings.

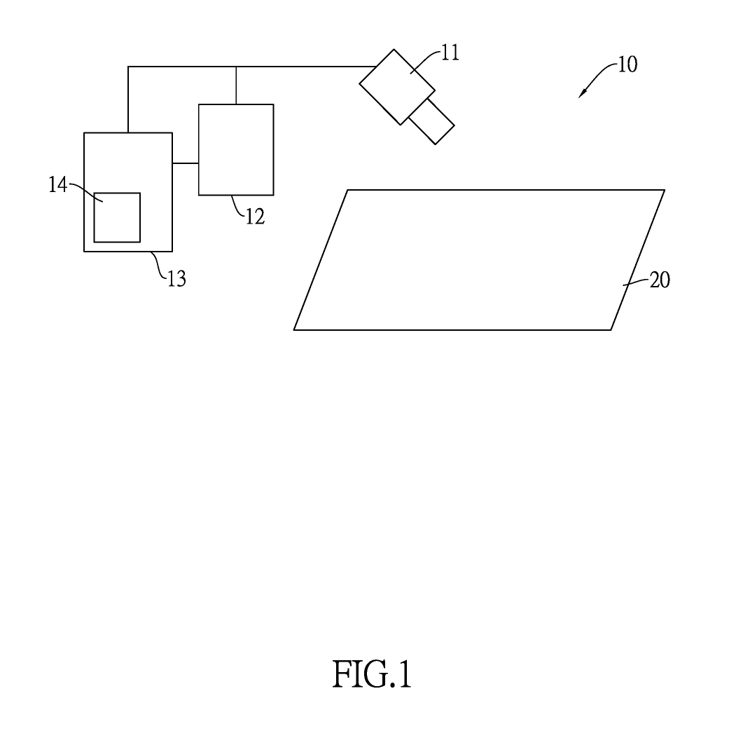

With reference to FIG. 1, the regional image scanning system 10 includes at least one image device 11, a mobile device 12, a controlling and driving device 13 and an image processing device 14. In the regional image scanning system 10, according to a size of a target object 20 or a requirement of an image quality of the target object 20, the regional image scanning system 10 may install one or multiple image devices 11 in the present invention, and it is not limited herein.

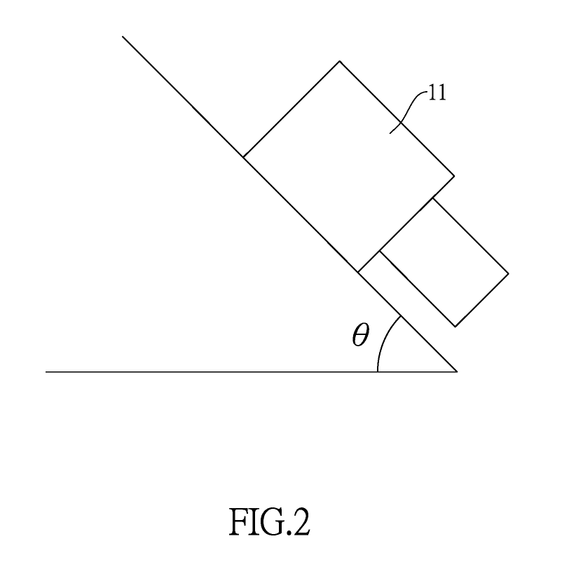

The image device 11 is installed on the mobile device 12. When the image device 11 is installed on the mobile device 12 as shown in FIG. 2, the image device 11 is tilted at an angle θ relative to a horizontal plane and the angle θ is preferred to be greater than 0° and less than 90°. In the present invention, the image device is preferred to be a CCD (Charge Coupled Device). The image device 11 is moved by the mobile device 12 and the image device 11 sequentially captures a plurality of regional images of the target object 20. Specifically, the mobile device 11 moves the image device 12 isochronally and equidistantly, so the image device 12 may capture one of the regional images in a certain area of the target object 20 at each time.

The controlling and driving device 13 is connected to the image device 11 and the mobile device 12. The controlling and driving device 13 is connected to the image device 11 and the mobile device 12 by a wired or wireless method. For example, the wireless connection can be BLUETOOTH, IR (Infrared Ray) or wireless network, and it is not limited herein. The controlling and driving device 13 receives the regional images captured by the image device 11 and controls a moving speed, a moving time period or a moving distance of the mobile device 12.

Moreover, the image processing device 14 is disposed within the controlling and driving device 13 and the image processing device 14 may be software installed in the controlling and driving device 13 to process the regional images. Specifically, the image processing device 14 performs an image integration and process for the regional images and merges the regional images to be a complete picture.

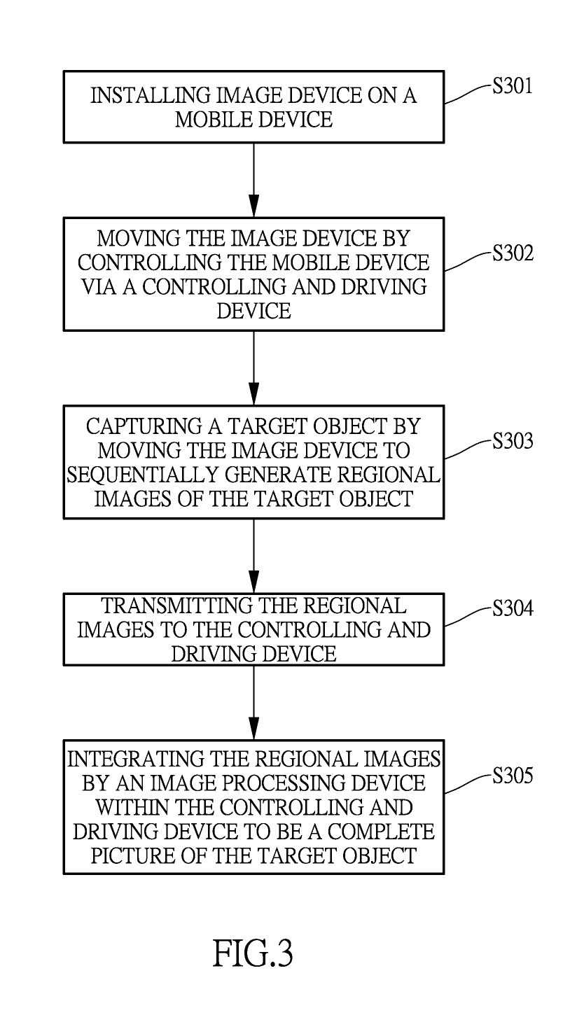

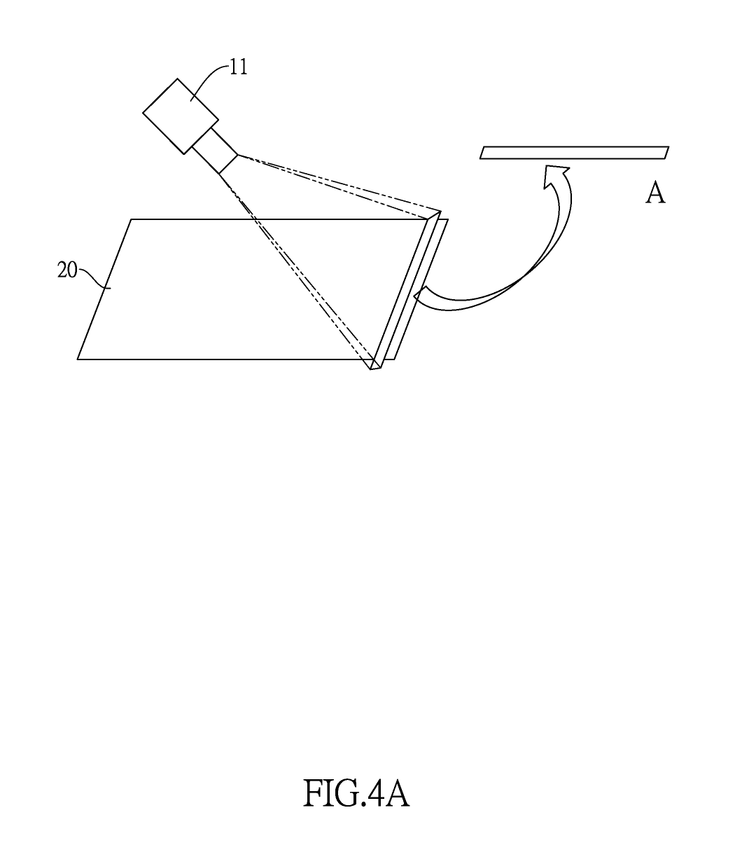

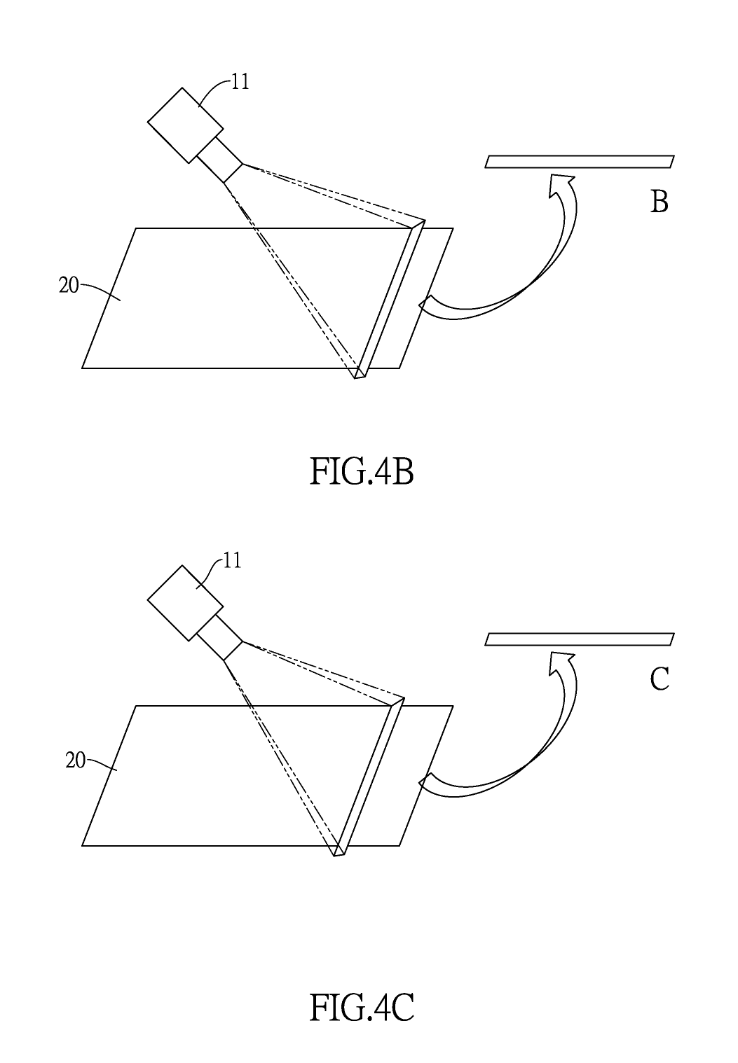

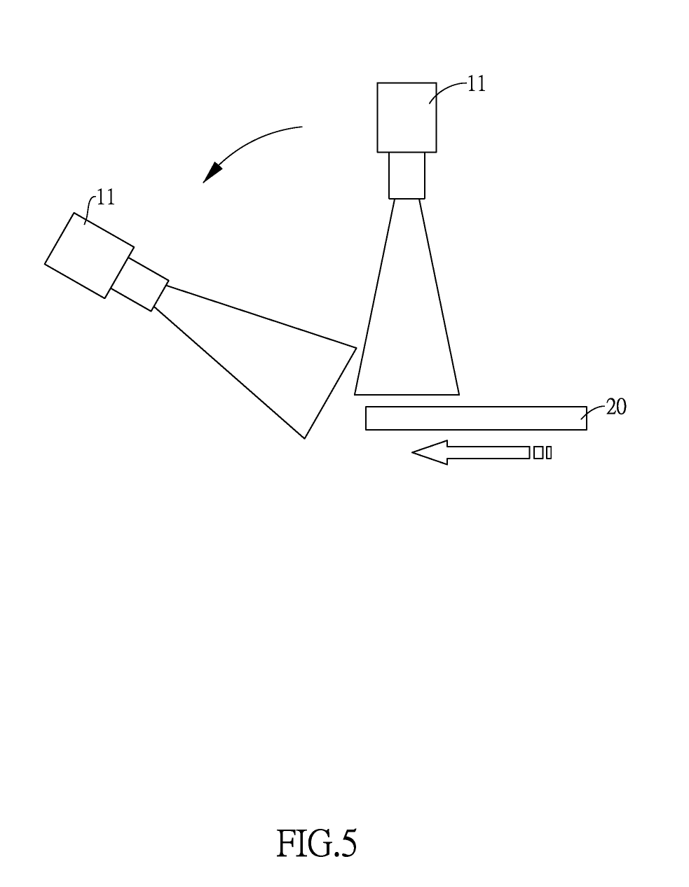

With reference to FIG. 3 and FIG. 4A to FIG. 4C, a regional image scanning method in the present invention includes the following steps. In step S301, at least one image device 11 is installed on a mobile device 12 and the image device 11 is tilted at an angle relative to the horizontal plane. According to different target objects 20 of different sizes, different numbers of the image devices 11 can be installed in the mobile device 12 in the regional image scanning system 10 of the present invention. For example, if the target object is an electronic component, a capturing range in one image device 11 may include all areas of the electronic component. If the target object is a vehicle component, a few of the image devices 11 are required to capture all areas of the vehicle component. In addition, since the image device 11 is tilted relative to the horizontal plane and the angle is preferred to be greater than 0° and less than 90°, the image device 11 may capture the regional image at a lateral area of the target object 20, as shown in FIG. 5.

In step S302, the mobile device 12 moves the image device 11 isochronally and equidistantly by the controlling and driving device 13. Specifically, the controlling and driving device 13 is used to set the moving distance, the moving time and moving speed of the mobile device 12 for each time and the image device 11 may capture one of the regional images in a certain range of the target object 20 at every moving time. Therefore, the following image processing steps can be easily performed. When the image device 11 moves and captures the images isochronally and equidistantly at each time, the capturing range at each time is not overlapped to the previous capturing range or the overlapped ranges are all the same at each capturing time. Therefore, the following image processing time or a calculating time of the controlling and driving device 13 may be simplified.

In step S303, a plurality of regional images of the target object 20 are sequentially captured. Compared with the conventional line scanning method for the target object 20, the present invention captures the target object 20 in the regional image scanning method and the regional image with a certain range is captured at each time. Therefore, the detectable range is wider than the conventional line scanning method. In addition, each one of the regional images captured at each time is assigned with a respective one of serial numbers and the serial numbers can be used in the subsequent image processing.

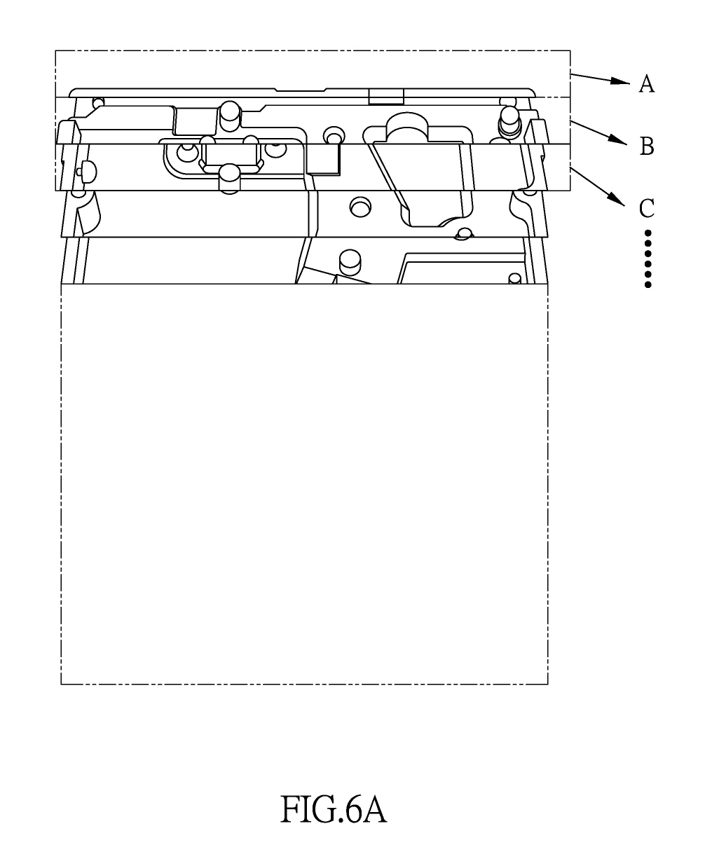

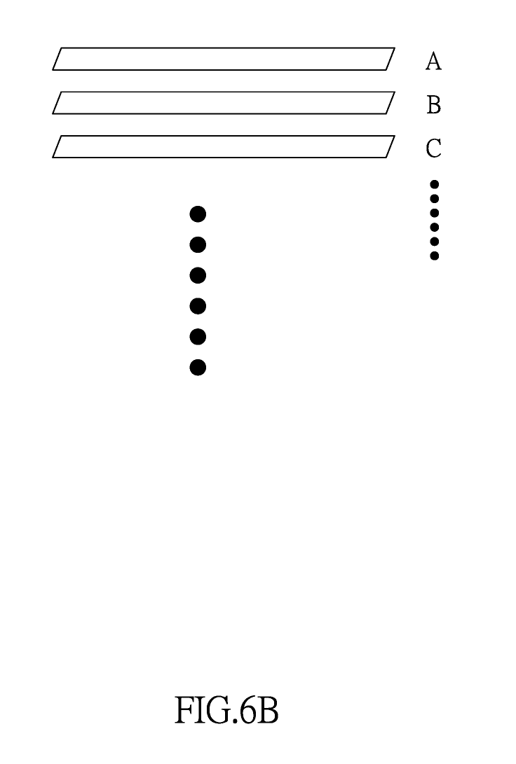

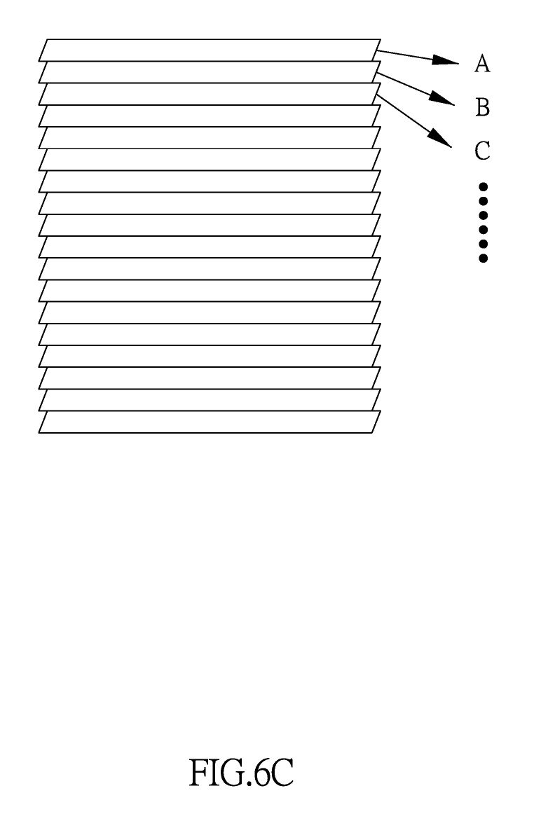

In step S304, the regional images are transmitted to the controlling and driving device 13. After the regional images have been captured, the regional images are sequentially transmitted to the controlling and driving device 13 to perform the following imaging process. Thereafter, in step S305, an image processing device 14 within the controlling and driving device 13 is used to integrate the regional images to be a complete picture for the target object 20. The image processing device 14 is software installed within the controlling and driving device 13. By the image processing device 14, the regional images transmitted to the controlling and driving device 13 are integrated and the regional images are sorted and merged in accordance with the serial numbers. For example, the image device 11 sequentially captures the certain ranges, and the captured images with the certain range are assigned with numbers as shown in FIG. 6A. Then, the captured images with the certain ranges (such as the images A, B and C in FIG. 6A, 6B and 6C) are transmitted to the controlling and driving device 13 and integrated by the image processing device 14 within the controlling and driving device 13, as shown in FIG. 6B. Finally, a complete picture for the target object 20 is obtained, as shown in FIG. 6C. The complete picture is compared with a reference picture. The reference picture is a picture of the target object 20 captured before, and the reference picture has been confirmed to be the picture of the target object 20 in normal. If the complete picture of the target object 20 is different from the reference picture, the target object 20 is abnormal.

According to the regional image scanning system and method in the present invention, a regular digital camera can be used to capture regional images. The target object 20 is captured in a regional scanning method and the image device 11 is tilted at an angle, so a lateral area of the target object 20 can be captured within a capturing range of the image device 11. Compared with the conventional line scanning method, the present invention captures images with a wider range.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A regional image scanning system, comprising:
a mobile device moving isochronally and equidistantly;
at least one image device installed on the mobile device and sequentially capturing a plurality of regional images of a target object, and the at least one image device tilted at an angle relative to a horizontal plane;
a controlling and driving device connected to the at least one image device to receive the regional images and connected to the mobile device to adjust a moving speed and a moving distance of the mobile device; and
an image processing device disposed within the controlling and driving device to process the regional images.

2. The regional image scanning system as claimed in claim 1, wherein the image processing device processes the regional images to be a complete picture of the target object.

3. The regional image scanning system as claimed in claim 1, wherein each one of the at least one image device is a Charge Coupled Device (CCD).

4. The regional image scanning system as claimed in claim 1, wherein the angle is greater than 0° and less than 90°.

5. The regional image scanning system as claimed in claim 1, wherein each of the regional images includes a serial number.

6. A regional image scanning method, comprising steps of:
installing at least one image device on a mobile device and the at least one image device tilted at an angle relative to a horizontal plane;
moving the at least one image device isochronally and equidistantly by controlling the mobile device via a controlling and driving device;
capturing a target object by moving the at least one image device to sequentially generate a plurality of regional images of the target object;
transmitting the regional images to the controlling and driving device; and
integrating the regional images by an image processing device within the controlling and driving device to be a complete picture of the target object.

7. The regional image scanning method as claimed in claim 6, wherein the capturing step is further to generate a plurality of serial numbers for the regional images.

8. The regional image scanning method as claimed in claim 7, wherein the integrating step is to integrate the regional images to be the complete picture of the target object in accordance with the serial numbers of the regional images.

9. The regional image scanning method as claimed in claim 6, wherein the installing step is to move the at least one image device to make one lateral area of the target object located within a capturing range of the at least one image device.
